(19) United States
(12) Patent Application Publication
(10) Pub. No.: US 2018/0258343 A1
(43) Pub. Date: Sep. 13, 2018

(54) PROPPANTS HAVING FINE, NARROW PARTICLE SIZE DISTRIBUTION AND RELATED METHODS

(71) Applicant: Imerys Oilfield Minerals, Inc., Roswell, GA (US)

(72) Inventors: Robert J. PRUETT, Milledgeville, GA (US); Christopher J. STEPHENSON, Houston, TX (US); Berenice C. EVERETT, Tennille, GA (US); Parker BURDELL, Salisbury, MD (US); Tonia BOUTELLE, Sandersville, GA (US)

(21) Appl. No.: 15/762,568

(22) PCT Filed: Sep. 23, 2016
(86) PCT No.: PCT/US2016/053254

§ 371 Date: Mar. 23, 2018

Related U.S. Application Data
(60) Provisional application No. 62/232,849, filed on Sep. 25, 2015.

(51) Int. Cl. C09K 8/80

(52) U.S. Cl. CPC C09K 8/80; E21B 43/267

(57) ABSTRACT

A proppant may include particles including a sintered ceramic composition, wherein the particles have a particle size distribution such that less than 25 wt. % of the particles have a particle size less than 100 mesh, and wherein the particles have a particle size distribution such that less than 1 wt % of the particles have a particle size greater than 60 mesh. The particles may have a sphericity ranging from 0.4 to 0.9. A proppant may include particles including a sintered ceramic composition, wherein the proppant has a conductivity of at least 1.5 times the conductivity of 100 mesh sand. A method of treating a subterranean area around a well bore may include providing a fracturing fluid including such proppants, and injecting the fracturing fluid into the subterranean area around the well bore.

### CLAIM FOR PRIORITY

This PCT International Application claims the benefit of priority of U.S. Provisional Patent Application No. 62/232,849, filed Sep. 25, 2015, the subject matter of which is incorporated herein by reference in its entirety.

### FIELD OF THE DESCRIPTION

The present disclosure relates to proppants having a fine, narrow particle size distribution and related methods.

### BACKGROUND

Naturally occurring deposits containing oil and natural gas are located throughout the world. Given the porous and permeable nature of the subterranean structure, it is possible to bore into the earth and set up a well where oil and natural gas are pumped out of the deposit. These wells are large, costly structures that are typically fixed at one location. As is often the case, a well may initially be very productive, with the oil and natural gas being pumpable with relative ease. As the oil or natural gas near the well bore is removed from the deposit, other oil and natural gas may flow to the area near the well bore so that it may be pumped as well. However, as a well ages, and sometimes merely as a consequence of the subterranean geology surrounding the well bore, the more remote oil and natural gas may have difficulty flowing to the well bore, thereby reducing the productivity of the well.

To address this problem and to increase the flow of oil and natural gas to the well bore, a technique may be employed of fracturing the subterranean area around the well to create more paths for the oil and natural gas to flow toward the well bore. This fracturing may be performed by hydraulically injecting a fracturing fluid at high pressure into the area surrounding the well bore. This fracturing fluid is thereafter removed from the fracture to the extent possible so that it does not impede the flow of oil or natural gas back to the well bore. Once the fracturing fluid is removed, however, the fractures may tend to collapse due to the high compaction pressures experienced at well-depths, which may exceed 20,000 feet.

To reduce the likelihood of the fractures closing, a propping agent, also known as a “proppant,” may be included in the fracturing fluid, so that as much of the fracturing fluid as possible may be removed from the fractures while leaving the proppant behind to hold the fractures open. As used in this application, the term “proppant” refers to any non-liquid material that is present in a proppant pack (a plurality of proppant particles) and provides structural support in a propped fracture. A proppant particle may provide structural support in a fracture, and it may also be shaped to have anti-flowback properties. The term “proppant” may refer to a plurality of proppant particles.

Because there may be extremely high closing pressures in fractures, it may be desirable to provide proppants that have a high crush resistance. For example, the useful life of the well may be shortened if the proppant particles break down, allowing the fractures to collapse and/or clog with “fines” created by the broken-down proppant particles. For this reason, it may be desirable to provide proppants that are resistant to breakage, even under high crush pressures.

In addition, it may also be desirable to provide a proppant that packs well with other proppant particles and the surrounding geological features, so that the nature of this packing of particles does not unduly impede the flow of the oil and natural gas through the fractures. For example, if the proppant particles become too tightly packed and create low porosity, they may actually inhibit the flow of the oil or natural gas to the well bore rather than increase it.

The nature of the packing may also affect the overall turbulence generated as the oil or natural gas flows through the fractures. Too much turbulence may increase the flowback of the proppant particles from the fractures toward the well bore, which may undesirably decrease the flow of oil and natural gas, contaminate the well, cause abrasion to the equipment in the well, and/or increase the production cost as the proppants that flow back toward the well must be removed from the oil and natural gas. In addition, too much turbulence may also increase a non-Darcy flow effect, which may ultimately result in decreased conductivity.

In the typically massive hydraulic fracturing treatments of unconventional reservoirs (e.g., shale reservoirs, etc.), a highly complex fracture network may be very desirable in order to contact as much reservoir volume as possible and further to make the stimulation of such reservoirs economical. In order to form a complex fracture network, low viscosity fluids (e.g., water, slickwater, linear gel, etc.) may be typically pumped at very high flow rates into the reservoir. However, unlike the more viscous fracture fluids (e.g., cross-linked gels, etc.) typically used in conventional reservoirs, the proppant transport properties of the fluids used in fracturing unconventional reservoirs may be far less than ideal.

In order to penetrate the complex fracture network and prop open productive far-field fractures, operators and service companies have tended more toward using smaller mesh size proppants for these unconventional fracturing treatments. The use of smaller proppant sizes, such as those sometimes referred to as “30/50,” “40/70,” and even “100mesh” (e.g., sand), has proliferated during the recent boom in shale fracturing. These smaller particles typically travel farther and can penetrate the smaller and/or narrower fractures within the massive fracture network. In addition, the volume of 100mesh proppant (e.g., sand) pumped continues to grow with greater acceptance of these perceived transport benefits. Unlike the larger proppant mesh sizes, 100mesh is usually only available as a waste or co-product from the mining operations of frac sand suppliers and other sources. This 100mesh may have improved transport properties over larger proppant sizes, but there are few industry-wide quality specifications 100mesh as compared to other typical proppants. Currently, 100mesh sand is not regulated by typical API/ISO standards, for example, with respect to upper and lower bounding sizes, and other quality aspects, such as turbidity (dust), can be very high, which may raise silicosis concerns. Also, much of the 100mesh sand pumped may be from local sand deposits that have less than ideal mineralogy and grain morphology. The increased demand in 100mesh sand has also led to supply constraints and, in some instances, a higher quality 100mesh sand may command a premium price relative to the same quality larger mesh sand.

Thus, it may be desirable to develop proppants that mitigate or overcome one or more of these drawbacks with, for example, 100mesh sand. For example, it may be desirable to develop proppants having improved transport and/or abrasion characteristics.

The proppants and methods disclosed herein may mitigate or overcome possible drawbacks associated with conventional proppants and related methods.

### SUMMARY

According to one aspect, a proppant may include particles including a sintered ceramic composition, wherein the particles have a particle size distribution such that less than 25 wt. % of the particles have a particle size less than 100 mesh, and wherein the particles have a particle size distribution such that less than 1 wt % of the particles have a particle size greater than 60 mesh. The particles may have a sphericity ranging from 0.4 to 0.9.

According to a further aspect, a proppant may include particles comprising a sintered ceramic composition, wherein the particles have a particle size distribution such that less than 25 wt. % of the particles have a particle size less than 100 mesh, and wherein the particles have a particle size distribution such that less than 1 wt % of the particles have a particle size greater than 60 mesh. The proppant may have a conductivity of at least 1.5 times the conductivity of 100 mesh sand.

According to a further aspect, a proppant may include particles including a sintered ceramic composition, wherein the particles have a particle size distribution such that less than 25 wt. % of the particles have a particle size less than 100 mesh, wherein the particles have a particle size distribution such that less than 1 wt % of the particles have a particle size greater than 60 mesh, and wherein the particles have an irregular shape configured to form voids in a subterranean proppant pack.

According to a further aspect, a method of treating a subterranean area around a well bore may include providing a fracturing fluid including a proppant, and injecting the fracturing fluid into the subterranean area around the well bore. According to some aspects, the proppant may include proppant according to those disclosed herein.

In another aspect, the sintered ceramic particles described herein can be used as a component of metal casting media for use in applications such as foundry sand casting and/or investment casting. In one aspect, the sintered ceramic particles can have a high sphericity and narrow particle distribution, resulting in improved permeability and a reduction of gas defects in molds and castings in comparison to conventional natural sands typically used in metal casting. In another aspect, the sintered ceramic particles can also have a low coefficient of thermal expansion providing a reduction in surface defects and cracks in comparison to conventional natural sands typically used in metal casting.

It is to be understood that both the foregoing general description and the following detailed description are exemplary and explanatory only and are not restrictive of the invention.

### BRIEF DESCRIPTION OF THE DRAWINGS

FIG. 1 is a graph showing conductivity as a function of closure stress for exemplary proppant Sample 1.

FIG. 2 is a is a graph showing permeability as a function of closure stress for exemplary proppant Sample 1.

FIG. 3 is a histogram showing the particle size of Sample 1 before and after long-term conductivity testing to 12 k psi.

FIG. 4 is an electron micrograph of exemplary Sample 1.

FIG. 5 is an optical micrograph of a proppant pack after long-term conductivity testing to 12 k psi.

### DESCRIPTION OF EXEMPLARY EMBODIMENTS

Reference will now be made to exemplary embodiments.

According to some embodiments, a proppant may include particles including a sintered ceramic composition, wherein the particles have a particle size distribution such that less than 25 wt. % of the particles have a particle size less than 100 mesh (ASTM mesh), and wherein the particles have a particle size distribution such that less than 1 wt % of the particles have a particle size greater than 60 mesh. The particles may have a sphericity ranging from 0.4 to 0.9.

According to some embodiments, the particles may have a particle size distribution such that less than 20 wt. % of the particles have a particle size less than 100 mesh, such that less than 15 wt. % of the particles have a particle size less than 100 mesh, such that less than 10 wt. % of the particles have a particle size less than 100 mesh, or such that less than 5 wt. % of the particles have a particle size less than 100 mesh.

According to some embodiments, the particles may have a particle size distribution such that at least 75 wt. % of the particles have a particle size ranging from 80 mesh to 100 mesh. For example, the particles may have a particle size distribution such that at least 80 wt. % of the particles have a particle size ranging from 80 mesh to 100 mesh, such that at least 85 wt. % of the particles have a particle size ranging from 80 mesh to 100 mesh, such that at least 90 wt. % of the particles have a particle size ranging from 80 mesh to 100 mesh, or such that at least 95 wt. % of the particles have a particle size ranging from 80 mesh to 100 mesh.

According to some embodiments, the particles may have a particle size distribution such that less than 20 wt. % of the particles have a particle size greater than 80 mesh. For example, the particles may have a particle size distribution such that less than 15 wt. % of the particles have a particle size greater than 80 mesh, such that less than 10 wt. % of the particles have a particle size greater than 80 mesh, or such that less than 5 wt. % of the particles have a particle size greater than 80 mesh.

According to some embodiments, the particles may have a sphericity ranging from 0.5 to 0.9. For example, the particles may have a sphericity ranging from 0.6 to 0.9, a sphericity ranging from 0.7 to 0.9, a sphericity ranging from 0.8 to 0.9, a sphericity ranging from 0.85 to 0.9, a sphericity ranging from 0.4 to 0.8, a sphericity ranging from 0.5 to 0.8, a sphericity ranging from 0.6 to 0.8, a sphericity ranging from 0.7 to 0.8, or a sphericity ranging from 0.75 to 0.8.

According to some embodiments, the particles may have a roundness ranging from 0.4 to 0.9. For example, the particles may have a roundness ranging from 0.5 to 0.9, a roundness ranging from 0.6 to 0.9, a roundness ranging from 0.7 to 0.9, a roundness ranging from 0.8 to 0.9, a roundness ranging from 0.85 to 0.9, a roundness ranging from 0.4 to 0.8, a roundness ranging from 0.5 to 0.8, a roundness ranging from 0.6 to 0.8, a roundness ranging from 0.7 to 0.8, or a roundness ranging from 0.75 to 0.8.

The static settling of small particles within a fluid (terminal velocity) is primarily governed by Stokes' Law, which describes how the forces acting on a falling sphere are balanced by the viscous properties of the fluid in which the particles are moving. For a low viscosity fluid such as water or slickwater, minimal buoyancy is provided by the fluid to any suspended particles. For proppant particles suspended in low viscosity fracturing fluids, a smaller mesh size and/or lower density and/or “non-spherical” nature, may provide added buoyancy and/or suspension benefits.

According to some embodiments, the proppants disclosed herein may provide a desirable small particle size, low density, and as may be desired, some shape irregularity. Such proppants, according to some embodiments, may provide superior proppant characteristics relative to, for example, 100mesh sands. For example, one or more of particle size, density, and shape, may be controlled to provide enhanced suspension and transport properties as compared to, for example, 100mesh sands. In addition, such proppants may provide higher abrasivity for scouring purposes and/or may include a much lower dust content (i.e., a lower free silica content), for example, as compared to 100mesh sands. According to some embodiments, such proppants may have superior fracture conductivity, and may provide at least twice the conductivity as compared to a typical premium 100mesh sand (e.g., “northern type” 100 mesh sands) and as much as ten times the conductivity of some 100mesh sands (e.g., “local” 100mesh sands).

Without wishing to be bound by theory, it is believed that in the dynamic conditions associated with pumping a fracturing treatment at high rates, the same proposed benefits of smaller particle size, lower density, and “irregular shape” assumed for static settling, may provide even further transport benefit within narrow fractures, relating to the distance travelled before proppant settling and bed buildup may occur.

According to some embodiments, the sintered ceramic composition may be formed from a composition including at least 35 wt % alumina. For example, the sintered ceramic composition may be formed from a composition including at least 42 wt % alumina, or at least 44 wt % alumina.

According to some embodiments, a ceramic precursor may be used to form the ceramic proppants. Ceramic precursors may include an alumina- or aluminosilicate-containing material. The alumina- or aluminosilicate-containing material may include at least one of kaolin, ball clay, bauxitic kaolin, smectite clay, bauxite, gibbsite, boehmite, metakaolin, or diaspore. Other ceramic precursors may be used.

According to some embodiments, the proppant may have an absolute density ranging from 2.45 grams per cubic centimeter to 2.70 grams per cubic centimeter. For example, the proppant may have an absolute density ranging from 2.50 grams per cubic centimeter to 2.65 grams per cubic centimeter, or an absolute density ranging from 2.55 grams per cubic centimeter to 2.80 grams per cubic centimeter. According to some embodiments, the proppant may have an absolute density of less than 2.65 grams per cubic centimeter. For example, the proppant may have an absolute density of less than 2.63 grams per cubic centimeter, such as, for example, less than 2.60.

According to some embodiments, the proppant may have a bulk density ranging from 1.3 grams per cubic centimeter to 1.60 grams per cubic centimeter. For example, the proppant may have a bulk density ranging from 1.40 grams per cubic centimeter to 1.50 grams per cubic centimeter, or a bulk density ranging from 1.45 grams per cubic centimeter to 1.50 grams per cubic centimeter.

According to some embodiments, the proppant may have a 10,000 psi crush strength of less than 10 wt. % fines. For example, the proppant may have a 10,000 psi crush strength of less than 7 wt. % fines, or a 10,000 psi crush strength of less than 5 wt. % fines.

The crush strength of a proppant may be indicated from a proppant crush resistance test described in ISO 13503-2: “Measurement of Properties of Proppants Used in Hydraulic Fracturing and Gravel-packing Operations.” In this test, a sample of proppant is first sieved to remove any fines (i.e., undersized pellets or fragments that may be present), then placed in a crush cell where a piston is then used to apply a confined closure stress of some magnitude above the failure point of some fraction of the proppant pellets. The sample is then re-sieved and the weight percent of fines generated as a result of pellet failure is reported as percent crush. A comparison of the percent crush of two equally sized samples is a method of gauging the relative strength of the two samples.

According to some embodiments, the proppant may have a turbidity of less than 150 NTU. For example, the proppant may have a turbidity of less than 75 NTU, a turbidity of less than 60 NTU, or a turbidity of less than 50 NTU.

According to some embodiments, the proppant may have a conductivity of at least 200 milidarcy-ft (md-ft) at 2 lb/ft² at 10,000 psi. For example, the proppant may have a conductivity of at least 225 md-ft at 2 lb/ft² at 10,000 psi, such as, for example, at least 250 md-ft at 2 lb/ft² at 10,000 psi, at least 275 md-ft at 2 lb/ft² at 10,000 psi, at least 300 md-ft at 2 lb/ft² at 10,000 psi, or at least 325 md-ft at 2 lb/ft² at 10,000 psi. Conductivity is measured using API Recommended Practice 19D, “Measuring the Long-term Conductivity of Proppants.” The Ohio Sandstone cores described in this method can be substituted with 316 stainless steel cores having the same dimensions as the sandstone.

According to some embodiments, proppant may have a permeability of at least 10D at 2 lb/ft² at 10,000 psi. For example, the proppant may have a permeability of at least 12D at 2 lb/ft² at 10,000 psi, such as, for example, at least 14D at 2 lb/ft² at 10,000 psi, at least 15D at 2 lb/ft² at 10,000 psi, at least 16D at 2 lb/ft² at 10,000 psi, or at least 18D at 2 lb/ft² at 10,000 psi.

Permeability is part of the proportionality constant in Darcy's Law, which relates flow rate and fluid physical properties (e.g., viscosity) to the stress level applied to a proppant pack. Permeability is a property specifically relating to a proppant pack, not the fluid. Conductivity, on the other hand, describes the ease with which fluid moves through pore spaces in a proppant pack. Conductivity depends on the intrinsic permeability of a proppant pack as well as the degree of saturation. In particular, conductivity expresses the amount of water that will flow through a cross-sectional area of a proppant pack under the desired stress level.

According to some embodiments, the proppant may have a K-value of at least 11,000 psi. For example, the proppant may have a K-value of at least 11,500 psi, such as, for example, at least 12,000 psi, at least 12,500 psi, at least 13,000 psi, at least 13,500 psi, or at least 14,000 psi. The K-value classification for crush resistance is the stress at which the proppant remains at less than 10 wt. % crushed fines.

Without wishing to be bound by theory, it is believed that relatively smaller particles may be able to withstand higher stresses because there are many more particles per a given volume to spread the load over a greater number of point to point contacts.

According to some embodiments, the proppant may include particles including a sintered ceramic composition, wherein the particles have a particle size distribution such that less than 25 wt. % of the particles have a particle size less than 100 mesh, and wherein the particles have a particle size distribution such that less than 1 wt % of the particles have a particle size greater than 60 mesh. The proppant may have a conductivity of at least 1.5 times the conductivity of 100 mesh sand. For example, the proppant has a conductivity of at least 2.5 times the conductivity of 100 mesh sand, at least five times the conductivity of 100 mesh sand, at least 7.5 times the conductivity of 100 mesh sand, or at least ten times the conductivity of 100 mesh sand.

According to some embodiments, a method of making a sintered ceramic proppant may include providing a kaolin clay. The method may further include blunging the kaolin clay, agglomerating the kaolin clay, and sintering the agglomerated kaolin clay to produce a sintered ceramic proppant.

According to some embodiments, a kaolin clay, for example, a fine, blocky feed kaolin clay and optionally some gibbsite containing kaolin, may be transferred from storage to a blunger for blunging in a conventional manner known to those skilled in the art with inorganic or organic dispersant (e.g., TSPP, SHMP, Na-polyacrylate, and/or similar dispersants). Thereafter, the blunged feed kaolin clay may be wet-screened and degritted, after which the degritted feed kaolin clay may be fluidized for agglomeration. According to some embodiments, agglomeration may be performed using a spray fluidizer, such as, for example, a fluidizer marketed by NIRO. Following agglomeration, the feed kaolin clay may be green-screened, and undersized material may be recirculated to the fluidizer to serve as seeds. Thereafter, the feed kaolin clay may be sintered in a kiln. For example, the feed may be heated in a direct fired rotary kiln with the temperature being increased to between about 1400° C. to about 1500° C. within about an hour and thereafter cooled to near ambient temperature within about an hour. Thereafter, the sintered and cooled material may be fed to a screening tower to classify the sintered material into different grades (e.g., oversized, undersized, and dust). Thereafter, the final sintered ceramic proppant may be obtained.

According to some embodiments of this disclosure, a method of making a ceramic proppant may include adding a dry ceramic precursor to a granulator, adding a liquid to the granulator, granulating the dry ceramic precursor and the liquid to form densified granules, and firing the densified granules to form a ceramic proppant. According to some embodiments, the dry ceramic precursor may include an alumina- or aluminosilicate-containing material. Other dry ceramic precursors are contemplated.

Kaolin is sometimes referred to as china clay or hydrous kaolin, and contains predominantly the mineral kaolinite, together with small concentrations of various other minerals. Kaolinite may also be generally described as an aluminosilicate clay, or hydrous aluminosilicate (e.g., Al₂Si₂O₅(OH)₄).

Kaolin clays were formed in geological times by the weathering of the feldspar component of granite. Primary kaolin clays are those which are found in deposits at the site at which they were formed, such as those obtained from deposits in Southwest England, France, Germany, Spain, and the Czech Republic. Sedimentary kaolin clays are those which were flushed out from the granite matrix at their formation site and were deposited in an area remote from their formation site, such as in a basin formed in the surrounding strata.

Metakaolin is a form of calcined kaolin. Calcined kaolins are kaolins that have been converted from the corresponding (naturally occurring) hydrous kaolin to the dehydroxylated form by thermal methods. Calcination changes at least some of the kaolin structure from crystalline to x-ray amorphous. The degree to which hydrous kaolin undergoes changes in crystalline form may depend on the amount of heat to which it is subjected. Initially, dehydroxylation of the hydrous kaolin occurs on exposure to heat about 550° C. At temperatures below about 850-900° C., the kaolin may be considered to be virtually dehydroxylated with the resultant amorphous structure commonly being referred to as being a metakaolin. Calcination in this temperature range may be referred to as partial calcination and the product may also be referred to as a partially calcined kaolin. Further heating to temperatures above about 900-1000° C. results in further structural changes such as densification. Calcination at these higher temperatures is commonly referred to as being full calcination and the product may be referred to as fully calcined kaolin containing primary mullite. Additional calcination may cause formation of secondary mullite, which is a very stable aluminium silicate phase, along with other high temperature minerals such as cristobalite.

Methods for making metakaolin are established and known to those skilled in the art. The furnace, kiln, or other heating apparatus used to effect calcining of the hydrous kaolin may be of any known kind. Calcination of the hydrous kaolin may take place, for example, in an oxidizing atmosphere. A typical procedure may involve heating kaolin in a kiln, for example, in a conventional rotary kiln. As the kaolin proceeds through the kiln, it may have a starting moisture content of less than about 25% by weight to facilitate the extrusion of the kaolin, and the extrudate may then form into pellets as a result of the calcination process. A small amount of a binder may be added to the kaolin to provide “green strength” to the kaolin so as to prevent the kaolin from completely breaking down into powder form during the calcination process. The temperature within a kiln used to create metakaolin should be within a specified range, typically above about 850° C. but typically not greater than about 950° C. At approximately 950° C., amorphous regions of metakaolin begin to re-crystallize.

The period of time for calcination of kaolin to produce metakaolin is based upon the temperature in the kiln to which the kaolin is subjected. Generally, the higher the temperature, the shorter the calcination time, and conversely, the lower the temperature, the higher the calcination time.

The calcination process may include soak calcining in which the hydrous kaolin or clay is calcined for a period of time during which the chemistry of the material is gradually changed by the effect of heating. The soak calcining may be for a period of, for example, at least 1 minute, at least 10 minutes, at least 30 minutes, at least 1 hour, or more than 5 hours. Known devices suitable for carrying out soak calcining may include high temperature ovens, rotary kilns, and vertical kilns. Alternatively, the calcination process may include flash calcining, in which the hydrous kaolin is typically rapidly heated over a period of less than one second, such as, for example, less than about 0.5 seconds. Flash calcination refers to heating a material at an extremely fast rate, almost instantaneously.

According to some embodiments, the method may be performed without adding water to the granulator separate from the slurry. It is believed that in some embodiments, the slurry may provide sufficient water to create a composition sufficient for granulation. This may improve the overall flow and efficiency of a proppant-making process. According to some embodiments, the method may include adding water to the granulator prior to granulating the dry ceramic powder and the slurry.

According to some embodiments, the granulator may be any type of granulation device, such as, for example, an Eirich mixer, a pan pelletizer, or a pin mill.

According to some embodiments, the slurry may include a recycled proppant material. As use herein, the term “recycled proppant material” refers to proppant material that was segregated or set aside from a previous manufacturing process. For example, the recycled proppant material may include a fired (e.g., sintered or calcined) recycled proppant material. Examples of fired recycled proppant material include, but are not limited to, proppant particles that were fired from green bodies and screened after the firing process. Fired recycled proppant materials may include, for example, undersized fired particles and/or oversized fired particles formed during calcination or firing of the green proppants. According to some embodiments, the fired recycled proppant material may include fines from particles that were crushed or ground during processing. The recycled proppant material may include a green recycled proppant material. A green recycled proppant material may include, for example, green (e.g., unfired or unsintered) proppant particles such as those from a granulator, that have been screened or milled. Examples of green recycled proppant particles may include undersized granules or oversized granules that were segregated during manufacturing. According to some embodiments, the recycled proppant material may include oversized ceramic particles, undersized ceramic particles, or both. Selection of oversized or undersized particles may be performed, for example, by conventional screening methods or by classification methods, such as, for example, a hydrocyclone. According to some embodiments, the recycled proppant material may include a milled recycled proppant material, such as, for example, fired or green particle that has been milled to provide a desired size distribution. The recycled proppant material may have been optionally screened to narrow its particle size distribution. When oversized and undersized particles are used to form the slurry, the resulting slurry may have a multimodal particle size distribution, such as, for example, a bimodal particle size distribution resulting from one mode corresponding to the undersized particles and one mode corresponding to the oversized particles.

According to some embodiments, the slurry may include a solids component of the slurry is a different material from the dry ceramic precursor material. For example, the dry ceramic precursor material may include an unfired clay material, such as kaolin, and the slurry may include a fired version of the same material, such as, for example, sintered or calcined kaolin. For example, the dry ceramic precursor may include kaolin, and the slurry may include metakaolin. According to some embodiments, the dry ceramic precursor may include a metakaolin and the slurry may include a fired proppant material, such as, for example, undersized or oversized proppants from a screening operation or fines from proppant processing. In other embodiments, the dry ceramic precursor may include a ceramic precursor, such as, for example, powdered alumina, and the slurry may include a hydrous material, such as kaolin or green granules.

According to some embodiments, the slurry may have a solids content ranging from about 10 wt % to about 80 wt % of the slurry, such as, for example, ranging from about 10 wt % to about 50 wt %, or ranging from about 50 wt % to about 80 wt %. As used herein the solid content of the slurry refers to the weight of the insoluble material relative to the weight of the water in the slurry.

According to some embodiments, the dry ceramic precursor may include a binder. According to some embodiments, the slurry may include a binder. The slurry may include a binder, for example, when the insoluble material is a green or unfired composition that contains a binder, or a binder may be separately added to the slurry apart from the insoluble material. Exemplary binders or binding agents may include, for example, methyl cellulose, polyvinyl butyrals, emulsified acrylates, polyvinyl alcohols, polyvinyl pyrrolidones, polyacrylics, starch, silicon binders, polyacrylates, silicates, polyethylene imine, lignosulphonates, phosphates, alginates, and combinations thereof. Some possible solvents may include, for example, water, alcohols, ketones, aromatic compounds, and hydrocarbons.

According to some embodiments, the dry ceramic precursor may be sized using various milling or grinding techniques, including, for example, attrition grinding and autogenous grinding (i.e., grinding without a grinding medium), and may be ground either by a dry grinding or a wet grinding process. When the dry ceramic precursor is subjected to a wet grinding process, the resulting material may be dried before it is mixed with the slurry. The grinding may be accomplished by a single grinding step or may involve more than one grinding step.

Proper sizing prior to forming the proppants may increase the compacity of the feed and ultimately result in a stronger proppant or anti-flowback additive. In some embodiments, a jet mill may be used to prepare a first batch of particles having a first particle size distribution. In a jet mill, the particles are introduced into a stream of fluid, generally air, which circulates the particles and induces collisions between the particles. Using known techniques, the forces in the jet mill can alter the particle size distribution of the particles to achieve a desired distribution. For example, one may vary the type of fluid used in the mill, the shape of the milling chamber, the pressure inside the mill, the number and configuration of fluid nozzles on the mill, and whether there is a classifier that removes particles of a desired size while leaving others in the mill for additional milling. The exact configuration will vary based on the properties of the feed material and the desired output properties. The appropriate configuration for a given application can be readily determined by those skilled in the art.

In some embodiments, the dry ceramic precursor or solids component of the slurry may have a multimodal distribution of particles. According to some embodiments, a multimodal distribution may be created by jet milling more than one batch of particles and mixing the particles together. A multimodal distribution may optionally be sized in a ball mill. Similar to jet milling multiple batches to different particle sizes and mixing them, ball milling may result in a multimodal particle size distribution, which can improve the compacity of the powder. In contrast to a jet milling process, however, acceptable results may be achieved in a single ball-milled batch of particles (i.e., there is no requirement to prepare multiple batches and mix them). Of course, there is no technical reason to avoid combining multiple ball-milled batches, and some embodiments may involve ball milling multiple batches (or using other milling means) and mixing them to form a powder with a desired multimodal particle size distribution. In some embodiments, batches with two different particle size distributions can be simultaneously milled in the ball mill, resulting in a powder with a multimodal particle size distribution.

Mechanically, a ball mill contains a chamber in which the ceramic precursor and a collection of balls collide with each other to alter the precursor material's particle size. The chamber and balls are typically made of metal, such as aluminum or steel. The appropriate configuration for the ball mill (e.g., the size and weight of the metal balls, the milling time, the rotation speed, etc.) can be readily determined by those skilled in the art. The ball milling process can be either a batch process or a continuous process. Various additives may also be used to increase the yields or efficiency of the milling. The additives may act as surface tension modifiers, which may increase the dispersion of fine particles and reduce the chance that the particles adhere to the walls and ball media. Suitable additives are known to those skilled in the art and include aqueous solutions of modified hydroxylated amines and cement admixtures. In some embodiments, the ball mill may be configured with an air classifier to reintroduce coarser particles back into the mill for a more accurate and controlled milling process.

According to some embodiments, a method of preparing a mineral feed for forming ceramic proppants may include crushing the mineral ore via a crusher apparatus to form crushed mineral ore. The method may further include depositing the crushed mineral ore into a media mill and adding water and dispersant into the media mill to form a slurry of the crushed mineral ore. The method may further include operating the media mill to grind the crushed mineral ore to form a slurry of ground mineral ore, and separating media of the media mill from the slurry of the ground mineral ore. According to some embodiments, the mineral ore may include at least one of bauxite and kaolin. For example, the mineral ore may include at least one ore common to bauxite and common to kaolin, and crushing the ore may include crushing the at least one of crude bauxite and crude kaolin. According to some embodiments, the method may not include one or more of blunging the mineral ore, blunging the crushed mineral ore, or blunging the ground mineral ore.

According to some embodiments, the method may include feeding the crushed mineral ore from the crusher apparatus directly to the media mill. According to some embodiments, the media mill may include at least one stirred media mill, and operating the media mill may include operating the at least one stirred media mill. For example, the media mill may include media including at least one of steel media (e.g., half-inch steel media) and ceramic media (e.g., 16 by 20 mesh ceramic media). According to some embodiments, the at least one stirred media mill may include a sandgrinder or attrition mill, such as, for example, at least one of a grinder having bars perpendicular to a rotating shaft, such as an ECC grinder, or a grinder having a cage rotor on a rotating shaft, such as a GK grinder.

Examples of GK grinders and ECC grinders are disclosed in U.S. Pat. No. 3,750,710 and U.S. Patent Application Publication No. US 2004/0033765 A1, respectively. The ECC grinders may or may not include pitched rotors such as those disclosed in the U.S. patent publication, but may be otherwise similar.

According to some embodiments, operating the media mill to grind the crushed ore may include depositing the crushed ore into a first media mill (e.g., a primary media mill), and adding the water and the dispersant into the first media mill to form the slurry of the crushed mineral ore. According to some embodiments, the method may further include operating the first media mill to grind the mineral ore to form the slurry of the ground mineral ore, and depositing the slurry of the ground mineral ore into a second media mill (e.g., a secondary media mill). The method may further include operating the second media mill to grind the slurry of the ground mineral ore. According to some embodiments, the primary and secondary media mills may be the same type of media mill. According to some embodiments, the primary and secondary media mills may be different types of media mills.

According to some embodiments, the crusher apparatus may include at least one of a jaw crusher and a horizontal shaft impactor. Other suitable types of crushers are contemplated.

According to some embodiments, the dispersant may include at least one of sodium lignosulfonate, sodium polyacrylate, and sodium polyphosphate.

According to some embodiments, the slurry of the crushed mineral ore may have a solids content ranging from about 30 wt % to about 75 wt %. For example, the slurry of the crushed mineral ore may have a solids content ranging from about 45 wt % to about 70 wt % or from about 50 wt % to about 70 wt %. According to some embodiments, water may be added the slurry of ground mineral ore to reduce the solids content to about 50 wt %.

According to some embodiments, the method may further include raising the pH of the slurry of the crushed mineral ore to 7 or more. For example, the pH may be increased by adding ammonium hydroxide and/or other suitable additives to the slurry of the crushed mineral ore to increase the pH.

According to some embodiments, the method may further include separating any grit particles (e.g., quartz grit particles) from the slurry of the ground mineral ore. For example, separating the grit particles may include separating the grit particles via at least one of a hydrocyclone and a screen. For example, a 325 mesh (˜44 μm) screen may be used.

According to some embodiments, the method may further include agglomerating the ground mineral ore. For example, the method may further include feeding the slurry of the ground mineral ore into a spray-fluidizer and operating the spray-fluidizer to form green pellets. According to some embodiments, the method may further include sintering the green pellets to form ceramic proppants. According to some embodiments, the method may further include sizing the sintered pellets to form ceramic proppants. Conventional sizing techniques known in the art may be used.

According to some methods, crude bauxite and/or crude kaolin may be crushed via a crusher, such as a jaw crusher and/or a horizontal shaft impactor. Thereafter, the crushed mineral ore may be fed directly into a single stirred media mill or series of stirred media mills, such as, for example, one or more ECC media mills and/or GK media mills. Water and dispersant are added with the crushed ore into a primary stirred media mill to make a dispersed kaolin-water slurry having a solids content ranging from about 50 wt % to about 70 wt %. The media in the primary stirred media mill may be a half-inch steel media. In some examples, a secondary media mill may be used to further grind the ground mineral ores, and the secondary stirred media mill may use smaller media, such as, for example, 16 by 20 mesh ceramic media. The pH may be adjusted in the primary media mill using a pH adjuster such as ammonium hydroxide. The dispersant used in the primary stirred media mill may be a single dispersant, or when the mineral is bauxite, a combination of dispersants, such as, for example, sodium lignosulfonate, sodium polyacrylate, and/or sodium polyphosphate. A screen may be placed after the last stirred media mill in the sequence to separate out any grinding media contained in the slurry. For kaolin containing grit particles (e.g., quartz grit particles), a hydrocyclone and/or screen may be used to separate out those grit particles for removal. According to some methods, the final stage stirred media mill product may contain no unblunged kaolin aggregates and a paucity of bauxite particles.

As discussed previously, the proppants disclosed herein may be used for treating the subterranean are around a well bore. For example, a method of treating a subterranean area around a well bore may include providing a fracturing fluid including a proppant, and injecting the fracturing fluid into the subterranean area around the well bore. The proppant may be a proppant according to any proppants disclosed herein.

Also, as discussed previously, the sintered ceramic particles described herein can be used as a component of metal casting media for use in applications such as foundry sand casting and/or investment casting. The sintered ceramic particles can have a high sphericity, roundness, and narrow particle distribution, resulting in improved permeability and a reduction of gas defects in molds and castings in comparison to conventional natural sands typically used in metal casting. The sintered ceramic particles can also have a low coefficient of thermal expansion providing a reduction in surface defects and cracks in comparison to conventional natural sands typically used in metal casting.

### Examples

Two exemplary embodiments of proppants according to the present application were prepared. The content of the two samples is provided in Tables 1 and 2 below.

TABLE 1
Sample 1
Chemisty (wt. %)

| | |
|---|---|
| Na₂O | 0.17 |
| MgO | 0.06 |
| Al₂0₃ | 45.1 |
| SiO₂ | 50.7 |
| P₂0₅ | 0.07 |
| K₂O | 0.1 |
| CaO | 0.08 |
| TiO₂ | 2.68 |
| Fe₂O₃ | 1.03 |

TABLE 2
Sample 2
Chemistry (wt. %)

| | |
|---|---|
| Na₂O | 0.09 |
| MgO | 0.06 |
| Al₂0₃ | 44.6 |
| SiO₂ | 51.0 |
| P₂0₅ | 0.09 |
| K₂O | 0.11 |
| CaO | 0.07 |
| TiO₂ | 2.82 |
| Fe₂O₃ | 1.23 |

Table 3 below shows the particle size distribution of the proppant particles of exemplary Sample 1, and Table 4 below shows the particle size distribution (ASTM Mesh) of the proppant particles of exemplary Sample 2.

TABLE 3
Sample 1
ISO/API Sieve Analysis

| Sieve Size | Wt. % Retained |
|---|---|
| 50 | 0 |
| 70 | 0.8 |
| 80 | 68.5 |
| 100 | 28.3 |
| 120 | 2.3 |
| 140 | 0.1 |
| 200 | 0.0 |
| PAN | 0.0 |
| Mean (μm) | 186 |
| Median (μm) | 185 |

TABLE 4
Sample 2
ISO/API Sieve Analysis

| Sieve Size | Wt. % Retained |
|---|---|
| 50 | 0.2 |
| 70 | 5.6 |
| 80 | 51.7 |
| 100 | 39.4 |
| 120 | 3.0 |
| 140 | 0.0 |
| 200 | 0.0 |
| PAN | 0.0 |
| Mean (μm) | 186 |
| Median (μm) | 182 |

Table 5 below shows testing results for exemplary Sample 1, and Table 6 below shows testing results for exemplary Sample 2.

TABLE 5
Sample 1
ISO/API Results

| | |
|---|---|
| Turbidity (NTU's) | 99 |
| Absolute Density (g/cm³) | 2.63 |
| Bulk Density (g/cm³) | 1.47 |
| 10K Crush % Fines | 4.9 |
| Roundness | 0.8 |
| Sphericity | 0.8 |

TABLE 6
Sample 2
ISO/API Results

| | |
|---|---|
| Turbidity (NTU's) | 47 |
| Absolute Density (g/cm³) | 2.65 |
| Bulk Density (g/cm³) | 1.47 |
| 10K Crush % Fines | 4.1 |
| Roundness | 0.8 |
| Sphericity | 0.8 |

Tables 7 and 8 below show the conductivity and permeability, respectively of exemplary Sample 1.

TABLE 7
Sample 1 Conductivity

| | |
|---|---|
| 2000 | 1728 |
| 4000 | 1240 |
| 6000 | 909 |
| 8000 | 518 |
| 10000 | 365 |
| 12000 | 176 |

TABLE 8
Sample 1 Permeability

| | |
|---|---|
| 2000 | 87 |
| 4000 | 63 |
| 6000 | 47 |
| 8000 | 28 |
| 10000 | 20 |
| 12000 | 10 |

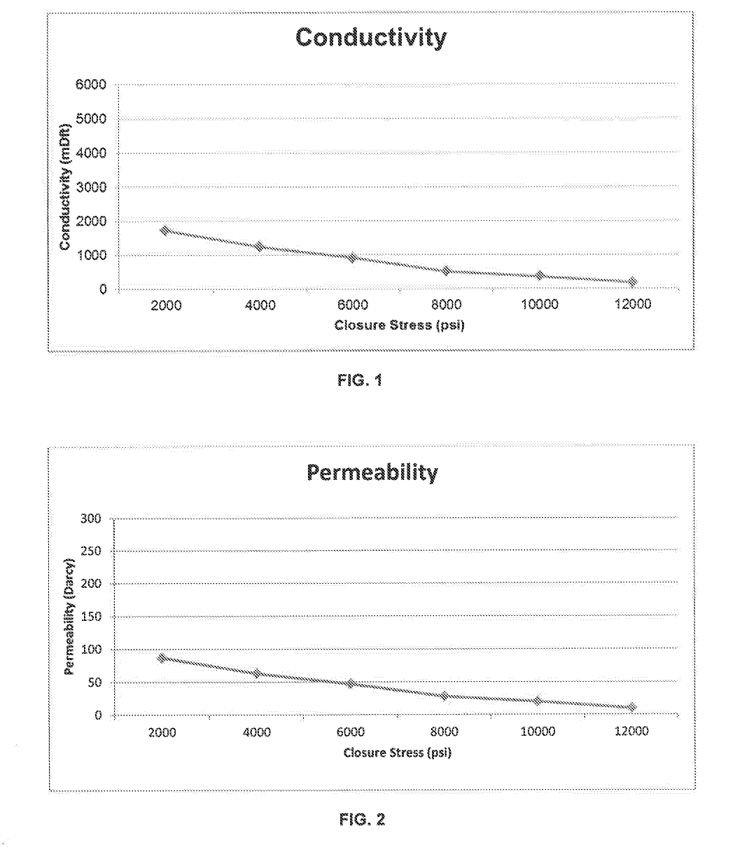

FIGS. 1 and 2 show graphs of the results shown in Tables 7 and 8.

As shown in Tables 5 and 6 above, Samples 1 and 2 show a surprisingly low turbidity. Without wishing to be bound by theory, it is believed that this may be a result of the narrow particle size distribution of Samples 1 and 2 and/or the low percentage of fines (e.g., particles smaller than 100 mesh).

TABLE 9
Sample 1 initial particle size and final particle size after
long-term conductivity test to 12k psi. Values are wt. %

| | | |
|---|---|---|
| 50 | 0.0 | 0.0 |
| 70 | 0.8 | 1.6 |
| 80 | 68.5 | 47.1 |
| 100 | 28.3 | 30.5 |
| 120 | 2.3 | 5.6 |
| 140 | 0.1 | 3.4 |
| 200 | 0.0 | 4.9 |
| Pan | 0.0 | 6.9 |

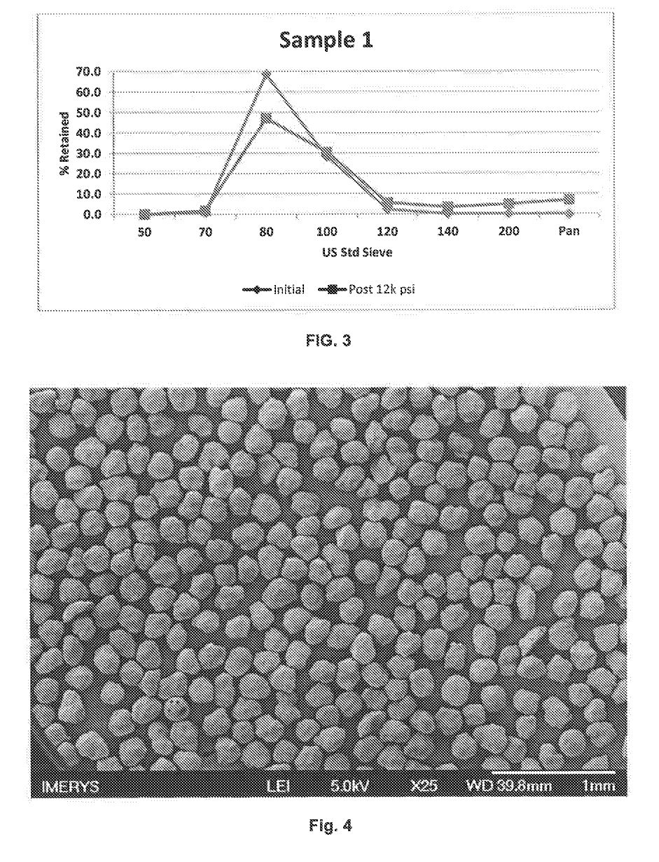

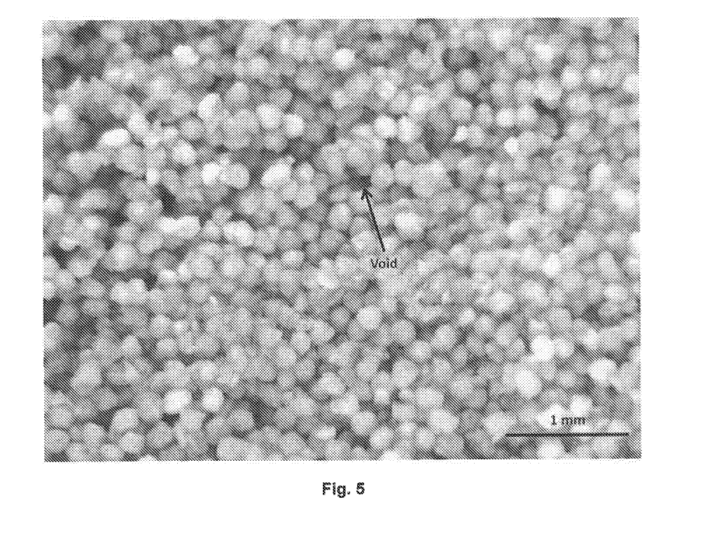

Referring to Tables 7 and 8 and FIGS. 1 and 2, Sample 1 shows a surprisingly low amount of crushed particles after 12,000 psi. For example, referring to FIG. 3 and Table 9, there are less than 25 wt. % fines less than 100 mesh and less than 10 wt. % fines in the pan. Imaging from the tested proppant pack from the conductivity test shows no visible fines and few broken particles. Without wishing to be bound by theory, the narrow distribution of particles combined with irregular surface may help form additional porosity by creating voids in the pack where a proppant particle is missing. FIG. 4 is an electron micrograph of Sample 1. FIG. 4 shows the irregular surfaces on the solid ceramic particles of Sample 1. FIG. 4 shows open voids in the proppant pack after long-term conductivity testing to 12,000 psi. Such a characteristic would not be anticipated with a well-rounded spherical population of proppant particles, with a 100 mesh natural sand, or both. Imaging also shows very few fines and fractured particles made after crushing to 12,000 psi. This is surprising considering the irregular shape of the particles in Sample 1.

Sample 1 according to an exemplary embodiment, was tested for crush strength to determine k-factor. Table 9 below shows the test results. These data correspond well to the long-term conductivity test data for Sample 1 post 12,000 psi.

TABLE 9
Sample 1 Crush Test

| | % FINES |
|---|---|
| 7.5K | 3.9 |
| 10K | 6.2 |
| 12K | 8.0 |
| 12.5K | 8.3 |
| 13K | 10.2 |

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A proppant comprising:
particles comprising a sintered ceramic composition,
wherein the particles have a particle size distribution such that less than 25 wt. % of the particles have a particle size less than 100 mesh,
wherein the particles have a particle size distribution such that less than 1 wt % of the particles have a particle size greater than 60 mesh, and
wherein the particles have a sphericity ranging from 0.4 to 0.9.

2. The proppant of claim 1, wherein the particles have a particle size distribution such that less than 20 wt. % of the particles have a particle size less than 100 mesh.

3-5. (canceled)

6. The proppant of claim 1, wherein the particles have a particle size distribution such that at least 75 wt. % of the particles have a particle size ranging from 80 mesh to 100 mesh.

7-10. (canceled)

11. The proppant of claim 1, wherein the particles have a particle size distribution such that less than 20 wt % of the particles have a particle size greater than 80 mesh.

12-14. (canceled)

15. The proppant of claim 1, wherein the particles have a sphericity ranging from 0.5 to 0.9.

16-24. (canceled)

25. The proppant of claim 1, wherein the particles have a roundness ranging from 0.4 to 0.9.

26-35. (canceled)

36. The proppant of claim 1, wherein the sintered ceramic composition is formed from a composition comprising at least 35 wt % alumina.

37. (canceled)

38. (canceled)

39. The proppant of claim 1, wherein the proppant has an absolute density ranging from 2.45 grams per cubic centimeter to 2.80 grams per cubic centimeter.

40. (canceled)

41. (canceled)

42. The proppant of claim 1, wherein the proppant has a bulk density ranging from 1.3 grams per cubic centimeter to 1.6 grams per cubic centimeter.

43. (canceled)

44. (canceled)

45. The proppant of claim 1, wherein the proppant has a 10,000 psi crush strength of less than 10% fines generated.

46. (canceled)

47. (canceled)

48. The proppant of claim 1, wherein the proppant has a turbidity of less than 150 NTU.

49-51. (canceled)

52. The proppant of claim 1, wherein the proppant has a conductivity of at least 200 md-ft at 2 lb/ft² at 10,000 psi.

53-56. (canceled)

57. A proppant comprising:
particles comprising a sintered ceramic composition,
wherein the particles have a particle size distribution such that less than 25 wt. % of the particles have a particle size less than 100 mesh,
wherein the particles have a particle size distribution such that less than 1 wt % of the particles have a particle size greater than 60 mesh, and
wherein the proppant has a conductivity of at least 1.5 times the conductivity of 100 mesh sand.

58. The proppant of claim 57, wherein the proppant has a conductivity of at least 2.5 times the conductivity of 100 mesh sand.

59-61. (canceled)

62. A proppant comprising:
particles comprising a sintered ceramic composition,
wherein the particles have a particle size distribution such that less than 25 wt. % of the particles have a particle size less than 100 mesh,
wherein the particles have a particle size distribution such that less than 1 wt % of the particles have a particle size greater than 60 mesh, and
wherein the particles have an irregular shape configured to form voids in a subterranean proppant pack.

63. A method of treating a subterranean area around a well bore, the method comprising:
providing a fracturing fluid including a proppant according to claim 1; and
injecting the fracturing fluid into the subterranean area around the well bore.

64-68. (canceled)

69. The proppant of claim 1, wherein the particles have a particle size distribution such that at least 75 wt. % of the particles have a particle size ranging from 80 mesh to 100 mesh.

70-74. (canceled)
